(19) United States
(12) Patent Application Publication
(10) Pub. No.: US 2007/0121454 A1
(43) Pub. Date: May 31, 2007

(54) Optical disk recognizing method and optical disk recording/reproducing apparatus applying it therein

(75) Inventors: Toshio Saitoh, Matsudo (JP); Kikuo Shimizu, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 11/488,339

(22) Filed: Jul. 17, 2006

(30) Foreign Application Priority Data
Nov. 30, 2005 (JP) 2005-345276

(51) Int. Cl. G11B 7/00

(52) U.S. Cl. 369/53.2; 369/53.31

(57) ABSTRACT

Within an optical disk recording/reproducing apparatus, in which a beam spot is irradiated upon an optical disk loaded therein, to obtain a reflection light obtainable therewith, and thereby conducting recording or reproducing of information upon an information recording surface of the optical disk, a microcomputer (μ-computer) 9 for controlling the operation of the apparatus executes a predetermined process by considering the optical disk loaded into the apparatus to be an optical disk, which is loaded previously, executes a retry process when determined that the optical disk loaded into the apparatus is not the optical disk loaded into the apparatus previously, as a result of the process mentioned above, executes a process for recognizing kind of the optical disk inserted, and memorizes information of the kind of the optical disk inserted into said apparatus, which is obtained in the recognizing process mentioned above, thereby shortening the startup time of the apparatus, as a whole thereof.

### BACKGROUND OF THE INVENTION

The present invention relates to an optical disk recognizing method for recognizing or discriminating various kinds of optical disks, each utilizing a light differing from each other in the wavelength thereof, for achieving recording/reproducing operation thereof, and further, it relates to an optical disk recording/reproducing apparatus applying that method therein.

The optical disks, as being a disc-like optical information recording medium, are widely used for recording/reproducing digital audio data and/or digital video data, to be an information recording medium for enabling data access at high speed, but without contact, with a large capacity and at a low cost, for example, and further, to be a data recording medium for a personal computer. In particular, in recent years, so-called next-generation DVDs (such as, a Blu-ray Disc (BD:®) and/or a HD DVD (®), etc.) are proposed to be an optical disk, being re-writable and large in the memory capacity thereof. Accompanying with this, demands are made upon an optical disk apparatus, in particular, which enables to record/reproduce information onto/from such the various kinds of information recording media, and in such cases, it is necessary to discriminate (the kind of) the optical disk, which is loaded into the apparatus, with certainty. However, the process for discriminating the kind of the optical disk loaded therein is complex, and in actual, it is the process of taking a long time therein.

Then, a recording/reproducing apparatus, which is already known in the following Patent Document 1, for example, discloses therein a technology for achieving shortening of a startup time thereof; i.e., while storing history information into a memory provided outside the apparatus, including control information of the optical disks, which were inserted or loaded into that apparatus, before shut-off of an electric power source thereof, and then thereafter, when the electric power source is turned ON again, but keeping that optical disk to be inserted therein as it is, the optical disk is controlled with using the control information, which was previously used, as it is.

Patent Document 1: Japanese Patent Laying-Open No. 2004-118887 (2004).

### BRIEF SUMMARY OF THE INVENTION

However, with such the conventional art as was mentioned above, it is made upon a presumption that the same optical disk be inserted into the apparatus, which was inserted therein before shut-off of the electric power source, and therefore, sufficient consideration was not paid upon, for shortening the startup time of the apparatus, not only when the same disk is loaded, but also when anew optical disk is loaded therein, after turning the electric power source ON.

Namely, within the optical disk recording/reproducing apparatus, being compatible with such the next-generation DVDs in recent years, in addition to CD (i.e., Compact Disk) and DVD (i.e., Digital Versatile Disk), etc., for example, it is necessary to select one from three (3) kinds laser light beams, each being different in the wavelength from one another, depending the kind of the optical disk that is inserted or loaded therein. For that reason, i.e., for identifying the kind of the optical disk inserted, it is necessary to conduct the process for exchanging the laser light beam to be used, for example, and therefore it is required to shorten the time period for recognizing or discriminating the optical disk.

Then, according to the present invention, it is an object to provide an optical disk recognizing method for making short the processing time period for recognizing the optical disk, which is inserted or loaded into the apparatus, thereby enabling to shorten the startup time of the apparatus, as a whole thereof, and also an optical disk recording/reproducing apparatus applying it therein.

For accomplishing the object mentioned above, according to the present invention, firstly there is provided an optical disk recognizing method for recognizing an optical disk, to be executed for recognizing a kind of the optical disk loaded into an optical disk recording/reproducing apparatus, in which a beam spot is irradiated upon the disk loaded, to obtain a reflection light obtainable therewith, and thereby conducting recording or reproducing of information upon an information recording surface of said optical disk, comprising the following steps of: executing a predetermined process by considering the optical disk loaded into said apparatus to be an optical disk, which is loaded previously; executing a retry process when determined that the optical disk loaded into said apparatus is not the optical disk loaded into said apparatus previously, as a result of the process mentioned above; executing a process for recognizing kind of said optical disk inserted; and memorizing information of the kind of said optical disk inserted into said apparatus, which is obtained in said recognizing process mentioned above.

Also, for accomplishing the object mentioned above, according to the present invention, there is further provided an optical disk recognizing method for recognizing an optical disk, to be executed recognition of a kind of the optical disk loaded into an optical disk recording/reproducing apparatus, in which a beam spot is irradiated upon the optical disk loaded therein, to obtain a reflection light obtainable therewith, and thereby conducting recording or reproducing of information upon an information recording surface of said optical disk, comprising the following steps of: executing a predetermined process by considering the optical disk loaded into said apparatus to be an optical disk, which is loaded previously; executing a retry process when determined that the optical disk loaded into said apparatus is not the optical disk loaded into said apparatus previously, as a result of the process mentioned above; executing a process for recognizing kind of said optical disk inserted; and memorizing information of the kind of said optical disk inserted into said apparatus, which is obtained in said recognizing process mentioned above.

Further, according to the present invention, within the optical disk recognizing method and the optical disk recording/reproducing apparatus as mentioned above, preferably, selection is made on the kind of the disk, which is loaded therein by a large number of times, among optical disks, upon which the recognizing process is not executed within said apparatus, and said recognizing process is conducted in descending order of said number of times, or said recognizing process is conducted in increasing order of an amount of movement of a beam expander from present position thereof, among optical disks, upon which the recognizing process is not executed within said apparatus, or said recognizing process is conducted in descending order of work distance thereof, among optical disks, upon which the recognizing process is not executed within said apparatus, or said recognizing process is conducted in increasing order of disk recognition time thereof, among optical disks, upon which the recognizing process is not executed within said apparatus, in said retry process.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing the entire structures of an optical disk apparatus, according to an embodiment of the present invention;

FIG. 2 is a view for showing the detailed structures on an inside of a pickup, within the optical disk apparatus mentioned above;

FIG. 3 is a flowchart for showing the entire structures of an optical disk recognizing method, which is executed within the optical disk apparatus mentioned above;

FIG. 4 is a flowchart for showing processes, according to a first embodiment, which is executed within the optical disk recognizing method shown in FIG. 3, as a retry process thereof;

FIG. 5 is a flowchart for showing processes, according to a second embodiment, which is executed within the optical disk recognizing method shown in FIG. 3, as a retry process thereof;

FIG. 6 is a flowchart for showing processes, according to a third embodiment, which is executed within the optical disk recognizing method shown in FIG. 3, as a retry process thereof;

FIGS. 7(a) through 7(c) are views for showing the distance between an objective lens surface and disk surfaces of various kinds of optical disks, under the condition that a laser light beam is focused on information recording surface thereof; and

FIG. 8 is a flowchart for showing processes, according to a fourth embodiment, which is executed within the optical disk recognizing method shown in FIG. 3, as a retry process thereof.

### DETAILED DESCRIPTION OF THE INVENTION

Hereinafter, embodiments according to the present invention will be fully explained by referring to the attached drawings.

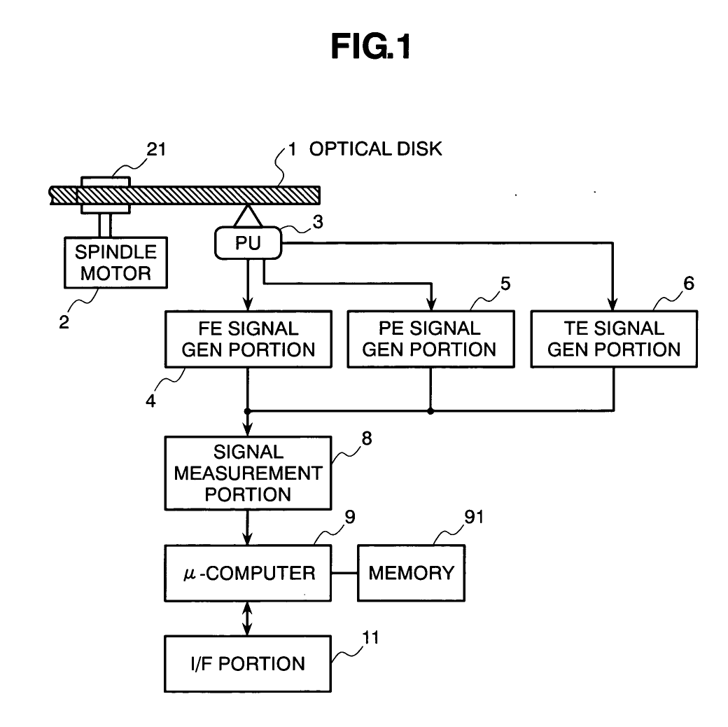

First of all, FIG. 1 is a view for showing the structures of the optical disk recording/reproducing apparatus, according to an embodiment of the present invention, and is a block diagram for showing the constituent elements thereof, mainly, for practicing the optical disk recognizing method according to the present invention.

First, FIG. 1 shows therein the entire structures of the optical disk recording/reproducing apparatus according to the embodiment of the present invention, wherein the apparatus comprises a spindle motor 2, and an optical disk 1, being one of various kinds of disks, onto/from which recording/reproducing is conducted by the apparatus, is mounted onto a turn table 21, which is attached at a tip of an output shaft of the motor, and thereby being rotationally driven at a predetermined speed. On the other hand, although the detailed structures thereof will be mentioned later, a pickup 3 irradiates a laser light beam of predetermined strength or intensity onto the optical disk 1, which is mounted thereon, while detecting a reflection light upon the said optical disk 1, to convert it into an electric signal. Upon basis of the detection signal from this pickup 3 are produced the following signals; i.e., a FE signal generator portion 4 produces a focus-error signal, a PE signal generator portion 5 produces a sum signal, and a TE signal generator portion 6 produces a tracking-error signal, respectively. Further, a signal measurement portion 8 measures a level of each of those signals, to be outputted into a microcomputer (μ-computer) 9. This μ-computer 9 compares a value of the level of the detection signal provided from the signal measurement portion 8 mentioned above, with a threshold value, which is memorized in advance within a memory 91, provided as a memorizing device thereof; thereby, conducting the recognition or discrimination on the kind of the optical disk loaded into the apparatus, as will be mentioned later, in more details thereof, as well as, recording/reproducing of information onto/from the information recording surface of the optical disk loaded into the apparatus, in a manner already know. Also, an interface (I/F) portion 11 in the figure transmits the contents of operations inputted by a user into the μ-computer 9, and it also outputs the information from the μ-computer 9 onto a display portion.

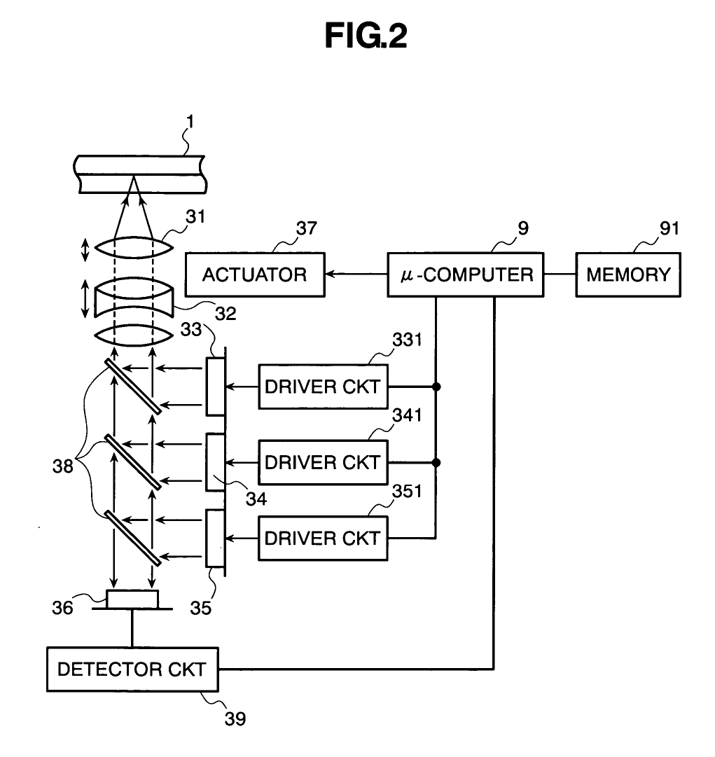

FIG. 2 attached herewith is a view for showing the detailed structures inside the pickup 3, in particular, within the optical disk apparatus, the entire structures of which was shown in the above. In this figure, the pickup 3 comprises an optic system, including an objective lens 31 and a beam expander 32 therein, as well as, laser-generating elements 33, 34 and 35 for generating laser lights, each being made up with a laser diode, for example, generating a laser light different from one another in the wavelength thereof, and further a light receiving element 36, which is made up with a photo diode, for example. However, the objective lens 31 is made a lens compatible with the three (3) wavelengths mentioned above, and is made movable into the direction perpendicular to the surface of the optical disk 1 (please see an arrow in the figure), together with the beam expander 32, which is constructed with a plural number of lenses, by means of an actuator utilizing electromagnetic force therein, for example. Also, those laser-generating elements 33, 34 and 35 are driven on light generations thereof, through-respective driver circuits 331, 341 and 351, responding to an instruction from the μ-computer 9 mentioned above. For example, the element 33 generates a laser beam of wavelength 405 nm for use of BD, the element 34 a laser beam of wavelength of 650 nm for use of DVD, and element 35 a laser beam of wavelength of 780 nm for use of CD, respectively. Also, a reference numeral 38 in the figure depicts so-called a half-mirror (or may be a polarization beam splitter, in the place thereof), being provided for reflecting the laser beams generated from the respective laser generator elements 33 to 35, thereby to irradiate it upon the surface of the optical disk 1 through the objective lens 31 and the beam expander 32, as well as, for passing through the reflection light upon the surface of that optical disk 1, thereby to guide it onto the light receiving element 36. Further, the refection light detected upon the light-receiving element 36 is detected within a detector circuit 39, to be converted into an electric signal.

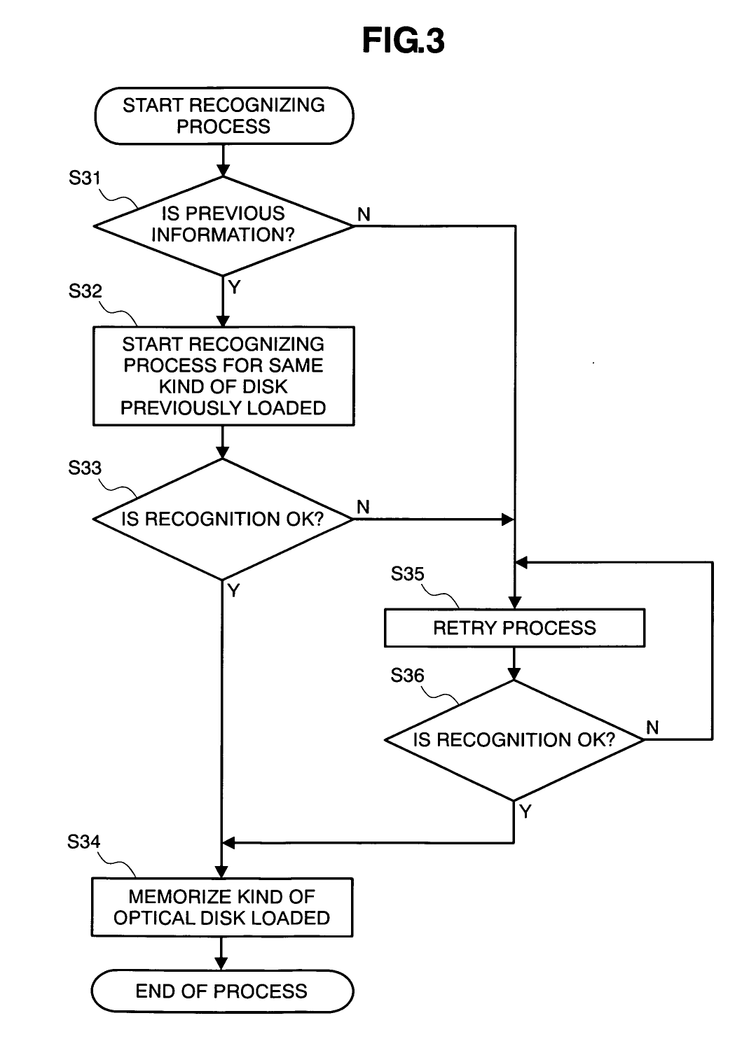

Following to the above, explanation will be given about the optical disk recognizing method according to the present invention. First, FIG. 3 attached herewith shows a flowchart for showing the entire structures of the optical disk recognizing method according to the present invention.

In the figure, when the optical disk is loaded therein, first, a recognizing process is started, i.e., determination is made on whether the same information (for example, a disk number: “previous information”) of the optical disk, which was loaded previously, is recorded on the optical disk or not, which is loaded at present (S31). As a result, if determining the previous information is thereon (“Y” in the figure), a recognizing process is started, for the same kind of disk that was loaded previously (S32). Thereafter, determination is made on whether the recognition can be made or not (S33), and as a result thereof, if determining that the recognition can be made (“Y” in the figure), the kind of the optical disk loaded at present is memorized into the memory 91, for example, as the memory device mentioned above (S34).

On the other hand, if determining that there is no previous information (“N” in the figure) as a result of the determination in S33 mentioned above, a retry process is executed (S35), and thereafter, it is determined on whether recognition of the optical disk can be made or not (S36). If determining that the recognition can be made (“Y” in the figure), the kind of the optical disk loaded is memorized into the memory 91 mentioned above (S34), and thereby completing a series of processes.

Thus, according to a basic flow of the optical disk recognizing method, according to the present invention, in case where the kind of the optical disk presently loaded into the apparatus is the same kind of the optical disk, which is loaded previously, the recognition process can be completed, normally. Then, after completion of this recognition, the kind of the optical disk loaded into the apparatus is stored into a memory area (i.e., the memory 91) within the apparatus. And, this information will be used in the recognizing process when a next optical disk is loaded.

However, herein, the kinds of disks mentioned above can be classified into three (3) groups, depending upon the laser beams differing from one another in the wavelength, to be used in recording/reproducing thereof for example; i.e., BD and HD-DVD (i.e., the next-generation DVDs) using the laser beam at wavelength 405 nm, DVD using the laser beam at wavelength 650 nm, and CD using the laser beam at wavelength 870 nm. Further, it is also possible to classify them, including other optical information recording media, such as, MD, etc., therein.

On the other hand, in case when the optical disk presently loaded into the apparatus differs from the optical disk previously loaded therein, in the kind thereof, or when the information relating to the kind of the optical disk, which was loaded previously, is not stored within the memory 91 in the apparatus, since it is impossible to recognize the optical disk, correctly, therefore the retry process mentioned above is executed. However, details of this retry process will be explained, hereinafter, by referring to the figures.

### FIRST EMBODIMENT

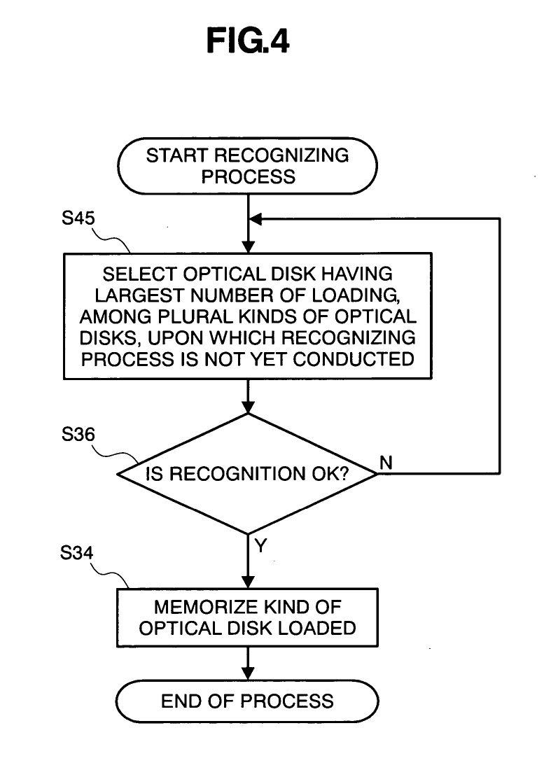

FIG. 4 attached herewith shows the recognizing method of the optical disk, according to a first embodiment of the present invention. With the method in this figure, within a side of the apparatus (i.e., the memory region (the memory 91) is stored the history of the optical disk which is loaded therein, thereby to be used as information thereof.

When determining that there is no previous information within the process S31 or when determining that recognition cannot be made on the disk within the process S33, in FIG. 3 mentioned above, then selection is made upon the kind or sort of disks being loaded into the apparatus at the largest number of times, among the kinds of disks, upon which the recognizing process is not yet carried out (S45). Thereafter, as is shown in FIG. 3 mentioned above, determination is made on whether recognition of the optical disk can be made or not (S36). If determining that the recognition can be made (“Y” in the figure), the kind of the optical disk loaded is memorized into the memory 91 mentioned above (S34), and thereby completing a series of processes.

Carrying out that recognizing process in an order of decreasing the number of times of loading, among the various kinds of optical disks which were loaded into the apparatus in the past, as was mentioned above, enables the recognizing operation adapting or fitting to the environment where that apparatus is used. Thus, it is possible to obtain the recognition, reflecting the environment of use for each of the apparatuses, most suitably.

However, as the method for selecting the optical disk in this instance, for example, the recognizing process may be carried out in the descending order of frequency thereof, upon basis of all information of the past, which are stored into the memory region (i.e., the memory 91) within the apparatus. Or, alternately, upon data of hundred (100) times in the past, for example, may be carries out the process in the descending order of frequency thereof. Or, the order thereof may be determined only upon the information going back to a predetermined time. Further, while obtaining frequencies of the kinds of disks, which are loaded after the loading of that kind of optical disk, from the information relating to the kinds of optical disks, which are loaded previously, it is also possible to determine the order of carrying out the processes, depending on that frequency information.

### Second Embodiment

FIG. 5 attached herewith shows the recognizing method of the optical disk, according to a second embodiment of the present invention.

However, in this method, as is shown in the figure, the order of executing the recognizing process is determined upon basis of the present position of the beam expander (seethe reference numeral 32 in FIG. 2). Thus, selection is made upon an optical disk of the kind, upon which the recognition can be made through a laser beam obtainable at the position of the beam expander, where an amount of change (or movement) is small from the present position thereof (i.e., near to the present position of the beam expander) (S55), and the recognizing process is executed in the order of the selection. Thus, determination is made on whether recognition can be made or not upon the optical disk (S36), and if determining that the recognition can be made (“Y” in the figure), the kind of the optical disk loaded is memorized into the memory 91 mentioned above (S34), and thereby completing a series of processes.

Within the optical disk recording/reproducing apparatus, in particular, being operable or compatible with three (3) kinds of laser beams being different in the wavelength from one another, an optic system is brought into the most suitable condition within an inside of the pickup (PU) 3, with using the beam expander 32 mentioned above. Since even the process of moving this beam expander takes a time required, therefore the recognizing process is executed in such the order that the moving distance from the present position comes to be shortest, while exchanging the beam expander; thereby shortening the time period for that recognition.

Although it was explained that the order of executing the recognizing process is determined upon basis of the position of the beam expander, in the explanation given in the above, however, it may be determined, not only the beam expander, but also the kinds of the laser beams to be used. Thus, it is preferable to execute the recognizing process, one by one, from the optical disk of that kind operable with the laser beam, which is presently used. This is because, it is necessary to wait for a moment until the laser beam is irradiated with stability, for example, when exchanging the laser beam to be used, and it is for omitting the time for stabilization thereof. Those processes mentioned above can be also executed by means of the μ-computer 9 (see FIG. 1 mentioned above), i.e., the processing device in the apparatus, upon basis of the past information stored into the memory region (i.e., the memory 91) within the apparatus.

### Third Embodiment

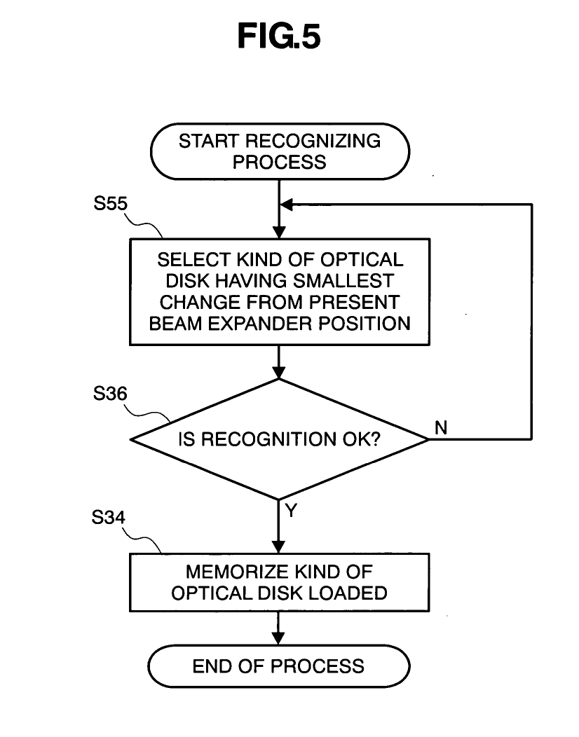

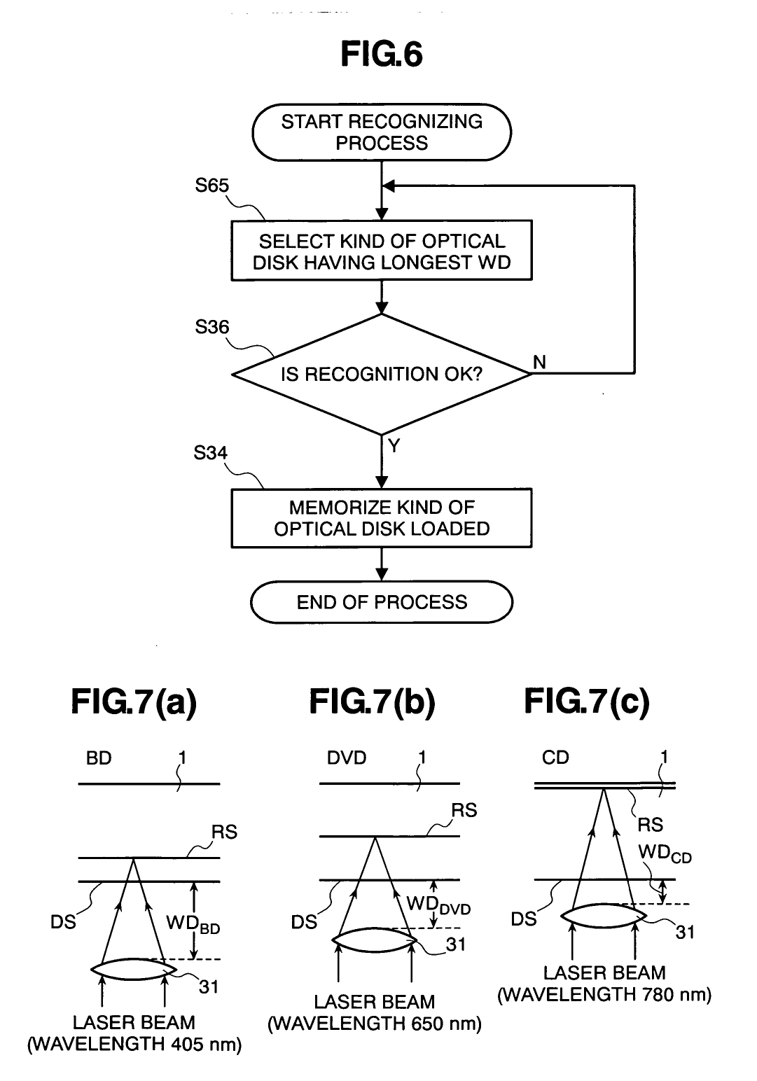

FIG. 6 attached herewith shows the recognizing method of the optical disk, according to a third embodiment of the present invention.

The recognizing method of the optical disk according to the third embodiment is one of executing the recognition process, one by one, from the kind of optical disk being long in so-called the work distance (“WD”: Work Distance). This is because the optical disk apparatus operable or compatible with the three (3) wavelengths has a tendency that “WD” to the optical disk is short, comparing to that of the conventional apparatus. Herein, “WD” means the distance between the objective lens 31 of the PU and the optical disk surface “DS” when a beam spot is focused on the information-recording surface, as is shown in FIGS. 7(a) through 7(c).

Thus, within the recognizing method of the optical disk, according to the present invention, selection is made in the order of the kinds of optical disks having long “WD”, in more details, BD (or HD-DVD), DVD and CD, in the order (S65). Thereafter, determination is made on whether recognition can be made or not upon the optical disk (S36), and if determining that the recognition can be made (“Y” in the figure), the kind of the optical disk loaded is memorized into the memory 91 mentioned above (S34), and thereby completing a series of processes.

With such recognizing method as was mentioned above, contact can easily occur between the pickup (PU), in particular, the objective lens 31 at the tip thereof, and the disk surface “DS” of the optical disk, as the distance of “WD” comes to be short, thereby giving damages upon both of them; however, executing the recognizing process from the optical disk of the kind having long “WD” enables to provide the apparatus hardly being damaged due to such the contact.

### Fourth Embodiment

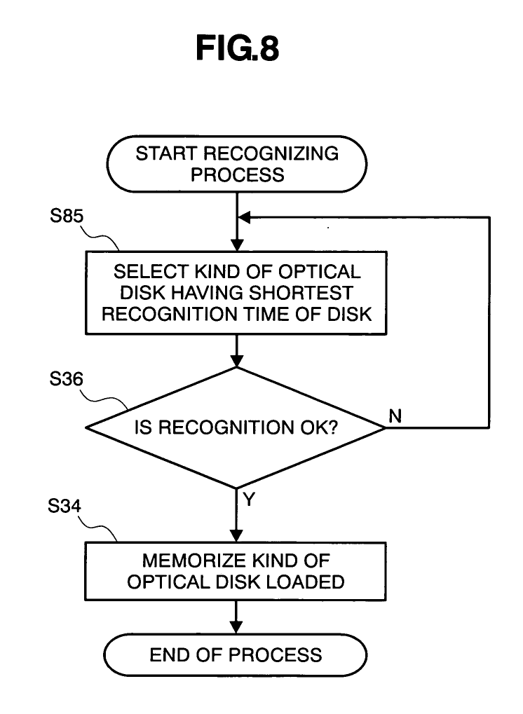

Further, FIG. 8 attached herewith shows the recognizing method of the optical disk, according to a fourth embodiment of the present invention.

The method shown in this figure is a one of executing that recognizing process from the kind of optical disk, upon which recognition time is short. Thus, the time necessary for recognizing the optical disk differs, greatly, depending upon the kind thereof. It is caused due to the fact that the contents of processes to be executed are different from. For example, with the recording medium, such as, DVD-RAM or the like, it is necessary to adjust a power of light irradiation, for conducting the recording operation thereon. On the contrary to this, in case of CD-ROM, for example, since only the reproducing operation can be conducted, there is no necessity of such process for adjusting the recording power as was mentioned above. In this manner, since the processes to be conducted differ, greatly, depending on the kinds of optical disks, therefore the times necessary for recognition thereof differ from.

Then, selection is made, sequentially, from the optical disk of the kind, upon which recognition time is short (S85), upon basis of the past information stored into the memory region (i.e., the memory 91) within the apparatus, so as to execute the recognizing method. With this, it is possible to conduct the recognizing process on the optical disk of the kind, upon which recognition time is short, but without delay, on the other hand, in connection with the optical disk of the kind, upon which recognition time is long, the recognition time is delayed or extended. However, inherently, since the time necessary for recognition thereof is long, therefore an amount of the delays comes to be less, relatively. Thus, it is possible to reduce a degree of ill influences exerted due to the optical disk of the kind, upon which recognition time is long. However, thereafter, in the similar manner to the above, determination is made on whether recognition can be made or not upon the optical disk (S36), and if determining that the recognition can be made (“Y” in the figure), the kind of the optical disk loaded is memorized into the memory 91 mentioned above (S34), and thereby completing a series of processes.

And, with installation of at lease one of the various kinds of retry processes, which are explained in the above, it is possible to provide the optical disk recognizing method, enabling to shorten the recognition time of the optical disk loaded therein, as well as, recognize it with certainty, and further the optical disk recording/reproducing apparatus, enabling to achieve shortening of the startup time with applying it therein.

As was mentioned fully in the above, according to the present invention, there can be achieved superior effect(s) of obtaining an optical disk recognizing method for making short the processing time period for recognizing the optical disk, which is inserted or loaded into the apparatus, thereby enabling to shorten the startup time of the apparatus, as a whole thereof, and also an optical disk recording/reproducing apparatus applying it therein.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. An optical disk recognizing method for recognizing an optical disk, to be executed recognition of a kind of the optical disk loaded into an optical disk recording/reproducing apparatus, in which a beam spot is irradiated upon the optical disk loaded therein, to obtain a reflection light obtainable therewith, and thereby conducting recording or reproducing of information upon an information recording surface of said optical disk, comprising the following steps of:
executing a predetermined process by considering the optical disk loaded into said apparatus to be an optical disk, which is loaded previously;
executing a retry process when determined that the optical disk loaded into said apparatus is not the optical disk loaded into said apparatus previously, as a result of the process mentioned above;
executing a process for recognizing kind of said optical disk inserted; and
memorizing information of the kind of said optical disk inserted into said apparatus, which is obtained in said recognizing process mentioned above.

2. The optical disk recognizing method, as is described in the claim 1, wherein selection is made on the kind of the disk, which is loaded therein by a large number of times, among optical disks, upon which the recognizing process is not executed within said apparatus, and said recognizing process is conducted in descending order of said number of times, within said retry process.

3. The optical disk recognizing method, as is described in the claim 1, wherein said recognizing process is conducted in increasing order of an amount of movement of a beam expander from present position thereof, among optical disks, upon which the recognizing process is not executed within said apparatus, within said retry process.

4. The optical disk recognizing method, as is described in the claim 1, wherein said recognizing process is conducted in descending order of work distance thereof, among optical disks, upon which the recognizing process is not executed within said apparatus, within said retry process.

5. The optical disk recognizing method, as is described in the claim 1, wherein said recognizing process is conducted in increasing order of disk recognition time thereof, among optical disks, upon which the recognizing process is not executed within said apparatus, in said retry process.

6. An optical disk recording/reproducing apparatus, comprising:
a laser beam source;
an objective lens for irradiating a laser beam upon an information recording surface of an optical disk; and
a controller for controlling operation of said apparatus, whereby recording or reproducing information upon/from the optical disk, wherein
said controller perform the following steps of:
executing a predetermined process by considering the optical disk loaded into said apparatus to be an optical disk, which is loaded previously;
executing a retry process when determined that the optical disk loaded into said apparatus is not the optical disk loaded into said apparatus previously, as a result of the process mentioned above;
executing a process for recognizing kind of said optical disk inserted; and
memorizing information of the kind of said optical disk inserted into said apparatus, which is obtained in said recognizing process mentioned above, thereby recognizing the kind of said optical disk loaded into said apparatus.

7. The optical disk recording/reproducing apparatus, as is described in the claim 6, wherein selection is made on the kind of the disk, which is loaded therein by a large number of times, among optical disks, upon which the recognizing process is not executed within said apparatus, and said recognizing process is conducted in descending order of said number of times, in said retry process executed by said controller.

8. The optical disk recording/reproducing apparatus, as is described in the claim 6, wherein said recognizing process is conducted in increasing order of an amount of movement of a beam expander from present position thereof, among optical disks, upon which the recognizing process is not executed within said apparatus, within said retry process executed by said controller.

9. The optical disk recording/reproducing apparatus, as is described in the claim 6, wherein said recognizing process is conducted in descending order of work distance thereof, among optical disks, upon which the recognizing process is not executed within said apparatus, within said retry process executed by said controller.

10. The optical disk recording/reproducing apparatus, as is described in the claim 6, wherein said recognizing process is conducted in increasing order of disk recognition time thereof, among optical disks, upon which the recognizing process is not executed within said apparatus, within said retry process executed by said controller.
